(19) United States
(12) Patent Application Publication
(10) Pub. No.: US 2011/0168791 A1
(43) Pub. Date: Jul. 14, 2011

(54) OUTDOOR UNIT OF AIR CONDITIONER

(75) Inventors: Hui Zhang, Guangdong (CN); Mingsheng Zhong, Guangdong (CN); Shaolin Chen, Guangdong (CN); Jun Xiong, Guangdong (CN); Zhi Meng, Guangdong (CN)

(73) Assignee: GREE ELECTRIC APPLIANCES INC. OF ZHUHAI, Zhuhai, Guangdong (CN)

(21) Appl. No.: 13/119,621

(22) PCT Filed: Sep. 14, 2009
(86) PCT No.: PCT/CN2009/001027

§ 371 Date: Mar. 17, 2011

(30) Foreign Application Priority Data
Sep. 18, 2008 (CN) 200820200683.5

(51) Int. Cl. G05D 23/00

(52) U.S. Cl. 236/51

(57) ABSTRACT

The present invention provides an outdoor unit of air conditioner comprising a main body and an electrical component box, a fan motor, a compressor and a condenser which are all installed in the main body. The electrical component box comprises an electrical box cover, an electrical box, and a circuit board on which electrical components and a radiator are installed. The circuit board is disposed in the electrical box, the electrical box cover is installed on top of the electrical box, and a baffle box is disposed between the electrical box and the fan motor. In the outdoor unit of air conditioner of the present invention, the baffle box is disposed between the electrical box and the fan motor, and encloses the electrical box from the fan motor, which keeps the electrical box and the fan motor apart, prevents the fan motor from burning resulting from the fire source in the electrical box and further protects the outdoor unit of air conditioner from burning.

### TECHNICAL FIELD

The present invention relates to equipment in the technical field of air conditioner, more particularly, to an outdoor unit of air conditioner.

### BACKGROUND OF THE INVENTION

The outdoor unit of air conditioner of the prior art comprises a main body and an electrical box therein. The main body holds a compressor, a heat exchanger, and a fan motor for the heat exchanger. The electrical box holds the electrical control components which drive and control the compressor, the fan motor, etc.

The electrical box comprises a circuit board, on which all the electrical control components comprising the rectifiers and the transistors for switching the converters are downwardly installed; and a component box which comprises a support member and a box body covering the support member. During the assembling of the electrical box, firstly, support the circuit board with support borders of the support member in the electrical box, then cover the support member with the box body, and enclose the circuit board with the box body and the support member. As seen from the configuration and the assembling method of the electrical box of the prior art, the electrical box is next to the fan motor installed in the main body, which will cause the fan motor burning easily when the components in the electrical box catch fire and will further cause the outdoor unit of air conditioner burning.

### SUMMARY OF THE INVENTION

The present invention provides an outdoor unit of air conditioner. The electrical box is isolated from the fan motor, which prevents the fan motor from burning when the components in the electrical box burn, and further prevents the outdoor unit of air conditioner from burning.

The present invention is carried out by the following technical scheme:

An outdoor unit of air conditioner, comprising a main body, and an electrical component box, a fan motor, a compressor and a condenser, which are all installed in the main body; the electrical component box comprises an electrical box cover, an electrical box, and a circuit board on which electrical components and a radiator are installed; the circuit board is fixed in the electrical box; the electrical box cover is installed on top of the electrical box; wherein a baffle box is disposed between the electrical box and the fan motor.

In the outdoor unit of air conditioner of the present invention, a baffle box is disposed between the fan motor and the electrical box, the baffle box can enclose the electrical box from the fan motor and make the electrical box isolated from the fan motor, which protects the fan motor from burning when the components in the electrical box catch fire and further prevents the outdoor unit of air conditioner from burning.

### BRIEF DESCRIPTION OF THE DRAWINGS

FIG. 1 is an exploded view illustrating the electrical component box of the outdoor unit of air conditioner of the present invention;

FIG. 2 is a side view illustrating the electrical component box of the outdoor unit of air conditioner of the present invention;

FIG. 3 is an exploded view illustrating the outdoor unit of air conditioner of the present invention;

FIG. 4 is a structural view illustrating the baffle box of the outdoor unit of air conditioner of the present invention.

### DETAILED DESCRIPTION OF THE PREFERRED EMBODIMENTS

The present invention will be described in more details with reference to the accompanying drawings and the preferred embodiments.

### The First Embodiment

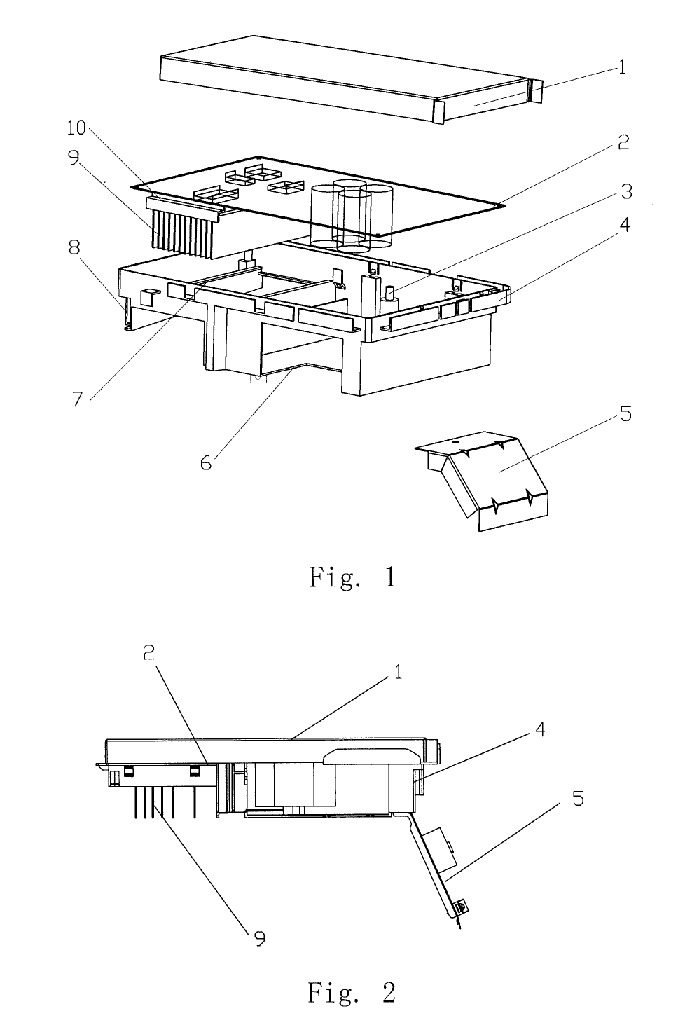

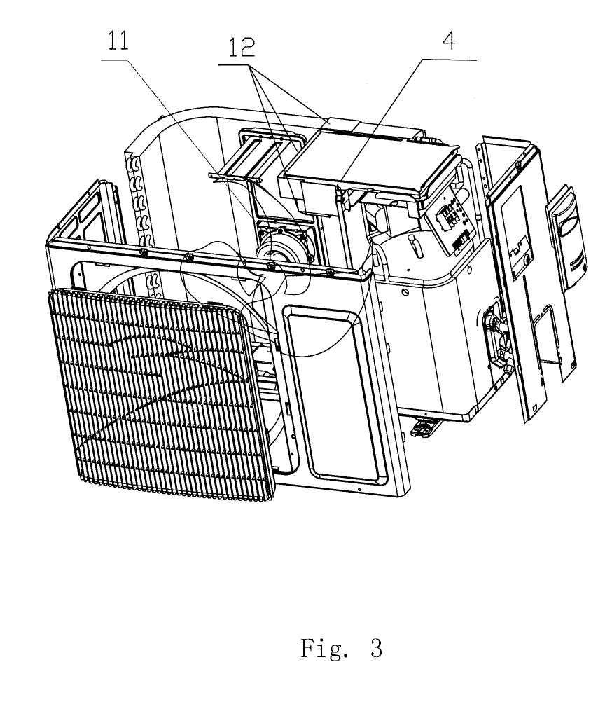

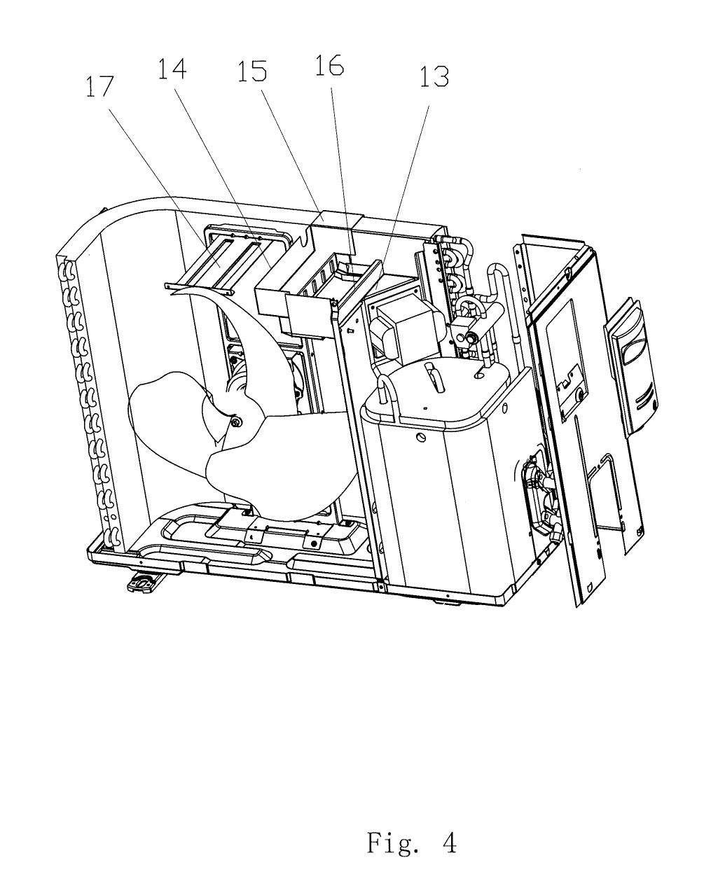

As shown in FIGS. 1 and 2, the outdoor unit of air conditioner of the present invention comprises a main body and an electrical component box installed in the main body. The electrical component box may be fixed on a baffle of the main body with screws in actual application. The electrical component box comprises an electrical box 4, an electrical box cover 1, and a circuit board 2 on which electrical components and a radiator 9 are installed. The circuit board 2 is fixed inside the electrical box 4. The side of the circuit board 2, installed with the electrical components and the radiator, is downwardly disposed, while the other side of the circuit board 2 fronts an opening of the electrical box. The electrical box cover 1 is installed on the top of the electrical box 4. Furthermore, a fan motor, a compressor, a condenser, etc. are installed in the main body. The fan motor, the compressor and the condenser are controlled by the electrical components. A baffle box 12 is fixed between the electrical box 4 and the fan motor 11. The baffle box 12 surrounds the electrical box. As shown in FIGS. 3 and 4, preferably, the left side 15 of the baffle box 12 may be fixed on the condenser 17 in the main body, the front side 16 of the baffle box 12 is fixed on the baffle 13 of the main body, so that the baffle box can enclose the electrical box 4 from the fan motor 11, which prevents the fan motor from burning resulting from the fire source in the electrical box and further protects the outdoor unit of air conditioner from burning. The baffle box 12 may be made of sheet metal which makes the electrical box 4 fireproof.

As seen from the above, in the outdoor unit of the air conditioner of the present invention, a baffle box is disposed between the fan motor and the electrical box, and the baffle box can isolate the fire source and further protect the outdoor unit of air conditioner from burning.

Preferably, the electrical box 4 may be made of injection material which can reduce the cost of the electrical component box and realize a good effect of assembly.

Preferably, the side of the circuit board, installed with the electrical components and the radiator, is downwardly disposed. The circuit board is fixed on an upper middle level of the electrical box, which creates passageways for air circulation to dissipate the heat of the electrical components and the radiator.

Preferably, the electrical box cover 1 is made of sheet metal, which makes the electrical components and the circuit board 2 in the electrical box 4 moistureproof, dustproof and fireproof. A module frame 10 may be further disposed and connected between the circuit board 2 and the radiator 9.

The top of the electrical box 4 is open. During assembling, firstly, place directly the circuit board 2 installed with the components and the radiator 9 inside the electrical box 4 through the top; secondly, fix the circuit board 2 on the electrical box 4 with screws; thirdly, install the electrical box cover 1 on the top of the electrical box 4 with screws or joggles. The electrical components and the radiator are downwardly installed on the circuit board, while the back of the circuit board fronts the opening of the electrical box. Furthermore, in the outdoor unit of the air conditioner of the present invention, the circuit board, installed with the components and the radiator 9, is fixed directly inside the electrical box. However, in the outdoor unit of the air conditioner of the prior art, the circuit board is fixed on a support, and it is needed to rearrange the circuit board before installing the box body. Compared with the prior art, the present invention has simple structure, is convenient for installation and has a better efficient of assembly. Moreover, the other side of the circuit board, without electrical components and radiators, fronts the electrical box cover, so that the pins in the back of the circuit board can be tested conveniently and quickly just when the electrical box cover is opened.

In order to further support the circuit board 2 and the radiator 9 stably, a support column 3 for supporting the circuit board 2 and a support pedestal 7 for supporting the radiator 9 are installed inside the electrical box 4.

In order to facilitate the heat emission of the electrical components and the radiator installed on the circuit board inside the electrical box, a ventilation duct 8 is disposed on the side of the electrical box which fronts the fan motor. The ventilation duct 8 fronts the circuit board 2. Air pressure difference will be formed between the fan motor and the compressor when the fan motor works, then wind blows the electrical components and the radiator and goes out through the ventilation duct 8, thereby it dissipates the heat of the electrical components inside the electrical box.

For the convenience of connecting the electrical components with the fan motor, the compressor, the heat exchanger and etc, a connection panel bracket 5 is fixed on an outer surface of the electrical box. A wiring area 6 is disposed at the bottom of the electrical box 4. In the wiring area, the electrical components connect with the fan motor, the compressor and the heat exchanger in the main body. The connection panel bracket 5 supports and bears the wires. Preferably, the connection panel bracket 5 can be fixed on the baffle of the main body, on the baffle box 12 or on the electrical box 4 with screws.

### The Second Embodiment

The second embodiment differs from the first embodiment in that, in the second embodiment, the top of the electrical box 4 is closed. The electrical component box comprises the electrical box and the circuit board on which the electrical components and the radiator are installed. The side of the circuit board, installed with the electrical components and radiators, is downwardly disposed, while the other side of the circuit board, without electrical components and radiators, is fixed on the top of the inner walls of the electrical box. Thus passageways for air circulation can be created to dissipate the heat of the electrical components and the radiator. In this embodiment, the circuit board is fixed upside down inside the electrical box, but it will be understood that the circuit board may be fixed upright or sideward inside the electrical box.

Other structures of the second embodiment are the same as those of the first embodiment, which will not be described here in details.

In summary, in the outdoor unit of air conditioner of the present invention, a baffle box is disposed between the fan motor and the electrical box. The baffle box can isolate the fire source created by the components in the electrical box and protect the outdoor unit of air conditioner from burning resulting from the sparks created by the components.

The preferred embodiments of the present invention described above are not intended to limit the present invention. Any modifications, equivalent substitutions or variations can be made without departing from the spirit and scope of the invention as defined in the claims.

1. An outdoor unit of air conditioner, comprising a main body, and an electrical component box, a fan motor, a compressor and a condenser, which are all installed in the main body; the electrical component box comprises an electrical box cover, an electrical box, and a circuit board on which electrical components and a radiator are installed; the circuit board is fixed in the electrical box; the electrical box cover is installed on top of the electrical box; wherein a baffle box is disposed between the electrical box and the fan motor.

2. The outdoor unit of air conditioner according to claim 1, wherein a left side of the baffle box is fixed on the condenser; and a front side of the baffle box is fixed on a baffle of the main body.

3. The outdoor unit of air conditioner according to claim 2, wherein, the left side of the baffle box is fixed on the condenser with joggles; and the front side of the baffle box is fixed on the baffle with screws or joggles.

4. The outdoor unit of air conditioner according to claim 1, wherein, the electrical box has a containing portion; one side of the circuit board installed with the electrical components and the radiator is downwardly disposed and held inside the containing portion; the circuit board is fixed inside the electrical box with screws; and the electrical box cover is fixed on the top of the electrical box with screws or joggles.

5. The outdoor unit of air conditioner according to claim 1, wherein a support column for supporting the circuit board and a support pedestal for supporting the radiator are disposed inside the electrical box.

6. The outdoor unit of air conditioner according to claim 1, wherein a ventilation duct is disposed on one side of the electrical box which fronts the fan motor; and the ventilation duct fronts the circuit board.

7. The outdoor unit of air conditioner according to claim 1, wherein the baffle box is made of sheet metal.

8. The outdoor unit of air conditioner according to claim 7, wherein a connection panel bracket made of sheet metal is installed on an outer surface of the electrical component box.

9. The outdoor unit of air conditioner according to claim 1, wherein the electrical box cover is made of sheet metal.

10. The outdoor unit of air conditioner according to claim 1, wherein the electrical box is made of injection material.
